(19) United States
(12) Patent Application Publication
(10) Pub. No.: US 2024/0427413 A1
(43) Pub. Date: Dec. 26, 2024

(54) INFORMATION PROCESSING APPARATUS, SERVER, DISPLAY METHOD AND STORAGE MEDIUM

(71) Applicant: Casio Computer Co., Ltd., Tokyo (JP)

(72) Inventor: Toshihiro KIUCHI, Tokyo (JP)

(21) Appl. No.: 18/739,007

(22) Filed: Jun. 10, 2024

(30) Foreign Application Priority Data
Jun. 26, 2023 (JP) 2023-103880

(51) Int. Cl. G06F 3/01; G06F 3/04817

(52) U.S. Cl. CPC G06F 3/011; G06F 3/04817

(57) ABSTRACT

An information processing apparatus includes, a display; a memory that stores a program; and at least one processor that executes the program. The processor is configured to, display each date of a predetermined period on the display in association with information indicating a record of a user's activity on the date, and perform statistical processing on the record of the user's activity during the predetermined period, and display a processing result of the statistical processing on the display.

### REFERENCE OF RELATED APPLICATIONS

The present application claims priority under Paris Convention to Japanese Patent Application No. 2023-103880, filed on Jun. 26, 2023, the disclosure of which, including description, claims, abstract and drawings, is incorporated herein by reference in its entirety.

### TECHNICAL FIELD

The present disclosure relates to an information processing apparatus, a server, a display method, and a storage medium.

### BACKGROUND OF THE INVENTION

Conventionally, Japanese Unexamined Patent Publication No. 2017-142831 discloses a mobile terminal device that can switch the display period of a schedule or calendar on a daily, weekly, or monthly basis.

### SUMMARY OF THE INVENTION

In order to solve the above problems, the information processing apparatus according to the present invention includes:

An information processing apparatus includes, a display; a memory that stores a program; and at least one processor that executes the program. The processor is configured to, display each date of a predetermined period on the display in association with information indicating a record of a user's activity on the date, and perform statistical processing on the record of the user's activity during the predetermined period, and display a processing result of the statistical processing on the display.

### BRIEF DESCRIPTION OF DRAWINGS

FIG. 1 is a diagram showing an example of an entire configuration of a statistical system according to an embodiment of the present disclosure.

FIG. 2 is a block diagram showing a functional configuration of an information processing apparatus shown in FIG. 1.

FIG. 3 is a flowchart showing a flow of a calendar statistical processing executed by a controller shown in FIG. 1.

FIG. 4 is a flowchart showing a flow of a summary statistics display processing executed by the controller shown in FIG. 1.

FIG. 5 is a diagram showing an example of a calendar screen in which a display period is “month”.

FIG. 6 is a diagram showing an example of a calendar screen in which a display period is “week”.

FIG. 7 is a flowchart showing a flow of a detailed statistics display processing executed by the controller shown in FIG. 1.

FIG. 8 is a diagram showing an example of a detailed statistics screen of a life log.

FIG. 9 is a diagram showing an example of a detailed statistics screen of running.

FIG. 10 is a diagram showing an example of a detailed statistics screen of learning.

FIG. 11 is a diagram showing an example of a setting screen for setting display conditions for icons in a calendar display region.

### DETAILED DESCRIPTION OF THE INVENTION

Hereinafter, embodiments to implement the present disclosure are described with reference to the drawings. However, various limitations that are technically preferable to execute the present disclosure are described in the embodiments below. Therefore, the technical scope of the present disclosure is not limited to the embodiments described below and the illustrated examples.

### [Configuration of Statistical System 100]

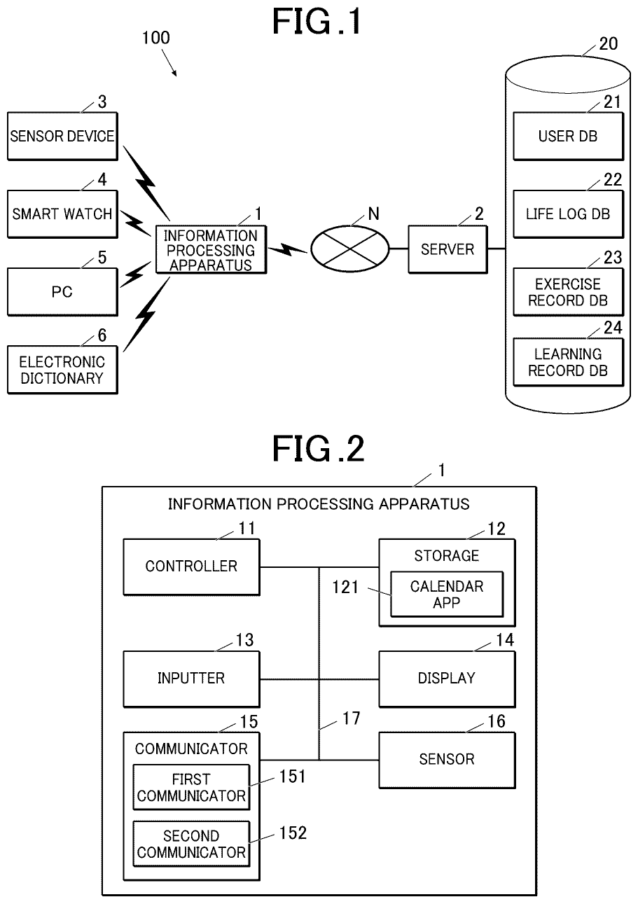

FIG. 1 is a diagram showing an example of a configuration of a statistical system 100 according to an embodiment of the present disclosure. As shown in FIG. 1, the statistical system 100 includes an information processing apparatus 1, a server 2, a sensor device 3, a smart watch 4, a PC (Personal Computer) 5, and an electronic dictionary 6. The information processing apparatus 1 is capable of transmitting and receiving data to and from the server 2 via a communication network N including a wireless LAN (Local Area Network) such as Wi-Fi, a mobile phone communication network, the Internet, and the like. Further, the information processing apparatus 1 is capable of transmitting and receiving data to and from the sensor device 3, smart watch 4, PC 5, and electronic dictionary 6 through wireless communication. Note that the number of devices included in the statistical system 100 is not particularly limited.

The information processing apparatus 1 includes, for example, a smartphone, a smart watch, a PC (Personal Computer), a tablet terminal, or the like. In this embodiment, a case where the information processing device 1 is a smartphone will be described as an example.

The information processing apparatus 1 acquires a user's activity record information from external devices such as the sensor device 3, the smart watch 4, the PC 5, and the electronic dictionary 6. Then, the information processing apparatus 1 associates the user's activity record information with each date on the calendar and displays information (icons, etc.) showing the record of activities by the user. The information processing apparatus 1 also performs statistical processing on the record of activities by the user, and displays the results of the statistical processing. The activity record information includes, for example, at least one of life log information, exercise record information, and learning record information. According to the present embodiment, the information processing apparatus 1 will be described as having a function of acquiring life log information, exercise record information, and learning record information as activity record information and statistically processing the acquired information.

As shown in FIG. 2, the information processing apparatus 1 includes a controller 11, a storage 12, an inputter 13 (operation inputter), a display 14, a communicator 15, and a sensor 16, and each unit is connected to each other through a bus 17.

The controller 11 is a computer that includes at least one central processing unit (CPU), a random access memory (RAM), and the like and controls each unit in the information processing apparatus 1. Specifically, the CPU of the controller 11 reads a designated program from among the system program and various application programs stored in the storage 12, deploys it in the RAM, and performs various processing such as a later-described calendar statistical processing in cooperation with the deployed program.

The storage 12 includes a nonvolatile semiconductor memory, a hard disk drive (HDD), or the like. The storage 12 stores system programs of the information processing apparatus 1, various application programs, and data necessary for executing the programs. The storage 12 is not limited to being provided inside the information processing apparatus 1, and may include an external storage medium that can be attached to and detached from the information processing apparatus 1.

According to the present embodiment, a calendar app 121 is stored in the storage 12. In addition, the storage 12 stores device IDs for identifying each device, such as the sensor device 3, smart watch 4, PC 5, and electronic dictionary 6, and the user ID of the user who uses the device, in association with each other.

The inputter 13 includes push button switches, a touch screen attached to the display 14, and the like. The inputter 13 outputs to the controller 11 operation signals input by the user with the push button switches and operation signals input with the touch screen.

The display 14 is configured with a display device such as a liquid crystal display or an organic EL (Electro Luminescence), and performs display based on the control operation by the controller 11.

The communicator 15 includes a first communicator 151 and a second communicator 152.

The first communicator 151 is a wireless communication module for wirelessly connecting with external devices such as the sensor device 3, smart watch 4, PC 5, and electronic dictionary 6 to transmit and receive data. According to the present embodiment, the first communicator 151 connects to an external device via Bluetooth (registered trademark) and transmits and receives data.

The second communicator 152 performs communication control for communicating with the server 2 and the like via the communication network N.

The sensor 16 is configured with a triaxial acceleration sensor, a triaxial gyro sensor, a GPS (Global Positioning System) sensor, a heart rate monitor, etc. The sensor 16 acquires measurement data such as acceleration, angular velocity, GPS information, heart rate, etc. and outputs the data to the controller 11.

The server 2 includes a controller, a communicator, etc. which are not shown, and a storage 20.

The storage 20 of the server 2 stores the calendar app 121 (not shown). In response to a request from the information processing apparatus 1, the server 2 provides the calendar app 121 to the information processing apparatus 1.

Further, the storage 20 of the server 2 is provided with a user database (DB) 21, a life log database (DB) 22, an exercise record database (DB) 23, and a learning record database (DB) 24.

The user DB 21 stores user information of the user who uses the calendar app 121. For example, the user DB 21 stores user information including user ID, password, user name, age, sex, height, weight, and the like.

The life log DB 22 stores life log information in association with the user ID.

The exercise record DB 23 stores exercise record information in association with the user ID.

The learning record DB 24 stores learning record information in association with the user ID.

The server 2 stores the user information, the life log information, the exercise record information, and the learning record information transmitted from the information processing apparatus 1 in the user DB 21, the life log DB 22, the exercise record DB 23, and the learning record DB 24, respectively. Further, the server 2 reads the life log information, the exercise record information, and the learning record information requested by the information processing apparatus 1 from the life log DB 22, exercise record DB 23, and learning record DB 24, respectively, and transmits them to the information processing apparatus 1.

The sensor device 3 the triaxial includes acceleration sensor, the triaxial gyro sensor, the GPS (Global Positioning System) sensor, the heart rate monitor, the altimeter, etc. The sensor device 3 is attached to a waist of the user, for example. The sensor device 3 acquires measurement data such as acceleration, angular velocity, GPS information, heart rate, etc. during the user's exercise from each of the above-mentioned sensors. Based on the acquired measurement data, the sensor device 3 generates exercise record information according to the type of exercise performed by the user. The generated exercise record information is associated with the device ID and transmitted to the information processing apparatus 1. The exercise record information includes, for example, if the type of exercise is running, the type of exercise (running), date and time of exercise, pace, time, running time, distance traveled, calories burned, heart rate, pitch [steps/min], stride [m], etc.

The smart watch 4 is equipped with a learning application (not shown), acquires record information (learning record information) of learning by the user using the learning application, associates the acquired learning record information with the device ID, and transmits the above to the information processing apparatus 1. In addition, the smart watch 4 is equipped with the triaxial acceleration sensor, the triaxial gyro sensor, the GPS sensor, the heart rate monitor, etc. From these measurement data, the smart watch 4 calculates the number of steps, calories burned, heart rate, sleep status, etc., associates the calculated result with the device ID and transmits the above to the information processing apparatus 1 as the life log information.

The PC 5 acquires the record information (learning record information) of the learning by the user using the learning tool (online or offline learning tool) installed in the storage (not shown) of the PC 5, associates the acquired learning record information to the device ID, and transmits the above to the information processing apparatus 1. The above learning tool is included in the learning app.

The electronic dictionary 6 acquires record information (learning record information) of learning by the user using the dictionary provided in the electronic dictionary 6, associates the acquired learning record information with the device ID, and transmits the above to the information processing apparatus 1.

Here, the smart watch 4, the PC 5, and the electronic dictionary 6 are collectively referred to as a learning device.

The common learning record information sent from each learning device to the information processing apparatus 1 includes, for example, the type of learning (type of learning device), learning date and time, amount of learning time, information about the learned subject (subject name, field name (e.g., English vocabulary, English grammar, English idioms, quadratic functions, factorization, differential and integral calculus, etc.), correct answer rate of questions in each field, etc.), and the like.

For example, the learning record information sent from the smart watch 4 to the information processing apparatus 1 includes, in addition to the above-mentioned common learning record information, the name of the application used, the location of learning (the location information obtained from the GPS installed in the smart watch 4), etc.

For example, the learning record information transmitted from the PC 5 to the information processing apparatus 1 includes, in addition to the above-mentioned common learning record information, information regarding the learning tools used (type of tool (name of online dictionary, vocabulary book, e-book, etc.), number of times the tool is used, number of times the information obtained with the tool is expanded into a digital notebook, information about the digital notebook (subject, number of times the function (text sticky note, camera sticky note, link sticky note, etc.) is used, information about the assignment (type of assignment (subject), number of submissions), and number of times the screen was shared. The digital notebook is one of the functions of the learning tool and is a tool that allows the user (students or teachers) to enter text, drawings, or images into a notebook, to save the information input in the notebook, and to share information input in the notebook with other users online. The text sticky note is a function that pastes text information input by the user onto the digital notebook. The camera sticky note is a feature that allows the user to import photos and videos taken with the camera into the digital notebook. The link sticky note is a function that pastes a link of a referenced web page onto the digital notebook.

For example, the learning record information transmitted from the electronic dictionary 6 to the information processing apparatus 1 includes, in addition to the above-mentioned common learning record information, the number of searches, information regarding the dictionary used (type of dictionary (e.g., English-Japanese dictionary, etc.)), dictionary name, number of pages referenced, type of word searched (noun, verb, etc.), number of times color markers or colored sticky notes were attached, number of memorization cards registered, and the like. Here, in the electronic dictionary 6, it is possible to attach a color marker or a color sticky note to the heading or explanation of the searched word, or to register the searched term in a memorization card and recall the term. Note that the above-mentioned number of searches may be both the total number of searches performed by the user (total number of searches using all dictionaries), and the number of searches for each dictionary, or may be either one.

### [Operation of Information Processing Apparatus 1]

Next, the operation of the information processing apparatus 1 in the statistical system 100 is described.

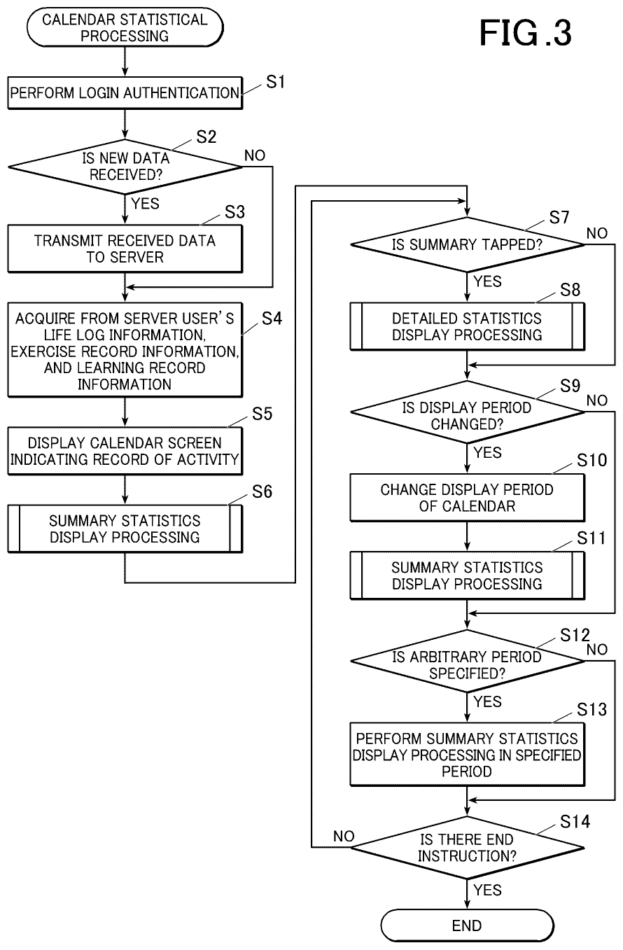

FIG. 3 is a flowchart showing the flow of the calendar statistical processing executed by the controller 11 when the calendar app 121 is activated in the information processing apparatus 1. The calendar statistical processing is performed by the controller 11 in coordination with the calendar app 121.

First, the controller 11 performs login authentication (step S1).

For example, the controller 11 displays a user ID and password input screen on the display 14 and transmits the user ID and password input through the inputter 13 to the server 2 through the communicator 15. The server 2 compares the input user ID and the password with the user ID and the password stored in the user DB 21. If there is a matching user ID and password, the server 2 notifies the information processing apparatus 1 that authentication is OK. When the controller 11 receives the notification that the authentication is OK from the server 2, the controller 11 proceeds to the processing of step S2 onwards.

In step S2, the controller 11 determines whether the first communicator 151 receives new data from an external device (registered sensor device 3, smart watch 4, PC 5, or electronic dictionary 6) (step S2).

That is, the controller 11 determines whether data of new life log information, exercise record information, or learning record information has been received from the external device.

Here, the controller 11 determines that new data has been received from the external device when the device ID of a data transmission source is the device ID corresponding to the user ID of the logged-in user.

If it is determined that new data has been received (step S2; YES), the controller 11 associates the received data with the user ID of the logged-in user and transmits it to the server 2 using the second communicator 152 (step S3). Then, the process proceeds to step S4.

When the server 2 receives data from the information processing apparatus 1, the server 2 stores the data of the life log information in the life log DB 22 in association with the user ID, stores the data of the exercise record information in the exercise record DB 23 in association with the user ID, and stores the data of the learning record information in the learning record DB 24 in association with the user ID.

If it is determined that no new data has been received (step S2; NO), the controller 11 advances the process to step S4.

In step S4, the controller 11 acquires the user's life log information, exercise record information, and learning record information for a predetermined period from the server 2 (step S4).

For example, the controller 11 makes a request to the server 2 through the second communicator 152 to acquire the user's life log information, exercise record information, and learning record information for the past year or so.

Next, the controller 11 causes the display 14 to display a calendar screen 141 showing a list of the record of the user's activity based on the acquired life log information, exercise record information, and learning record information (step S5).

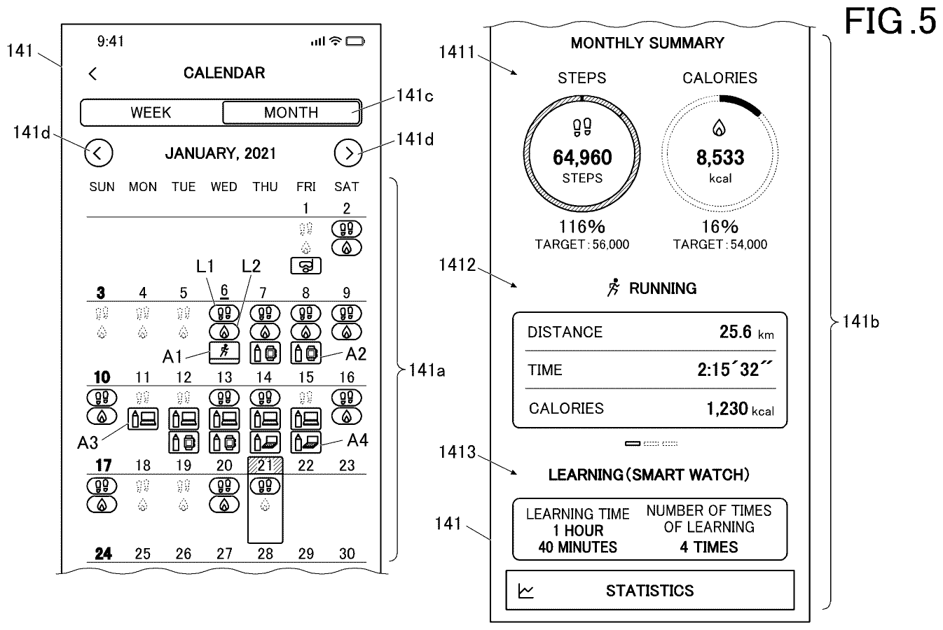

In step S5, the controller 11 displays on the display 14, for example, a calendar screen 141 (see FIG. 5) in which each date of the current month is displayed in association with information (icons) indicating the record of the activity of that day.

Next, the controller 11 performs the summary statistics display processing (step S6).

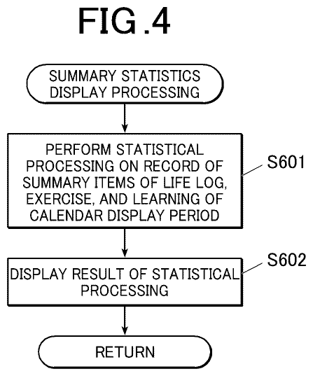

FIG. 4 is a flowchart showing a flow of the summary statistics display processing. The summary statistics display processing is performed by the controller 11 in coordination with the calendar app 121.

In the summary statistics display processing, the controller 11 first acquires the data of the items to be displayed in the summary of the life log information, exercise record information, and learning record information for the display period of the calendar, and performs statistical processing (step S601).

The controller 11 performs statistical processing for each type of activity. The types of activities can be broadly classified into life log, exercise, and learning. Detailed types of the life log include, for example, the number of steps, calories, sleep, and the like. Detailed types of exercise include, for example, running, trail running, biking, swimming, and the like. Detailed types of learning include, for example, learning (smart watch), learning (PC), learning (electronic dictionary), and the like. The items to be displayed in the summary are determined in advance for each type of activity. Alternatively, priorities may be set for each type of activity, and activities with higher priorities may display more items than activities with lower priorities. In addition, when adjusting and displaying the number of items to be displayed, a display priority for each item in the activity may be set and the display items of the activity in the summary may be set based on the displayable number and display priority.

Then, the controller 11 displays the results of the statistical processing on the calendar screen 141 (step S602), and proceeds to step S7 in FIG. 3.

FIG. 5 is a diagram showing an example of the calendar screen 141.

As shown in FIG. 5, the calendar screen 141 is provided with a calendar display region 141a, a summary region 141b, a display unit change button 141c, and a target period change button 141d.

The calendar display region 141a displays a calendar in which each date is displayed associated with information (icons L1, L2, A1 to A4, etc.) indicating the record of the user's activity on that day.

The icon L1 is an icon indicating that the number of steps has been entered in the life log. The icon L2 is an icon indicating that the calories burned has been entered in the life log. The icons L1 and L2 for days when the daily targets for the steps and burned calories are achieved are displayed surrounded by predetermined colors or lines, respectively. The icons L1 and L2 for days when the target was not achieved are displayed without being surrounded. Note that the icons L1 and L2 are not displayed on dates with no records (entry).

The icon A1 is an icon indicating that exercise has been performed. The icon A1 displays a pictogram representing one of the exercises performed that day. When a plurality of exercises have been performed, as shown in FIG. 5, the icon A1 is underlined to indicate that there are other exercises that have been performed. Note that the icon A1 is not displayed on dates with no records of exercises.

The icon A2 is an icon indicating that learning by the smart watch 4 has been performed. The icon A2 is not displayed on dates where there is no record of learning using the smart watch 4. The icon A3 is an icon indicating that learning has been performed by the PC 5. The icon A3 is not displayed on dates for which there is no data regarding the record of learning by the PC 5. The icon A4 is an icon indicating that learning using the electronic dictionary 6 has been performed. The icon A4 is not displayed on dates for which there is no record of learning using the electronic dictionary 6.

The summary region 141b is a region that shows simple statistics of the record for each type of activity during the display period of the calendar. In the summary region 141b, a life log record summary 1411, an exercise record summary 1412, and a learning record summary 1413 are displayed.

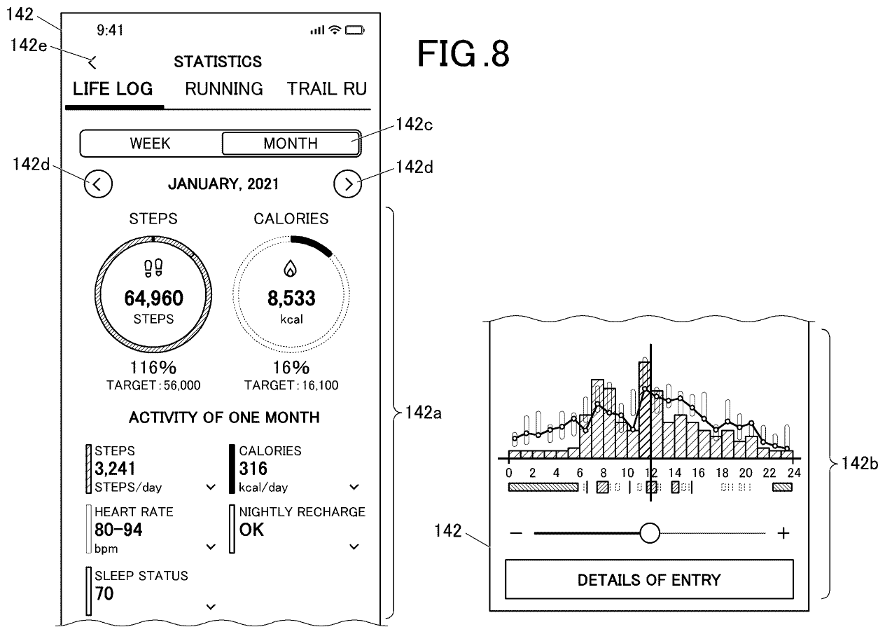

The life log performance summary 1411 displays, for example, the cumulative number of steps taken during the calendar display period, the cumulative calories burned, and the like. In the example shown in FIG. 5, the display period of the calendar (one month), so the cumulative number of steps, cumulative calories burned, etc. for one month are displayed. Here, for example, the cumulative number of steps represents the number of steps that have been recorded (entered) as a life log, that is, the total number of steps that have been recorded (entered) on the day on which the icon L1 is displayed. The same applies to other items (cumulative calories burned, cumulative exercise record, and cumulative learning record). When the life log record summary 1411 is tapped, the controller 11 displays a life log record detailed statistics screen 142 (see FIG. 8). In the example shown in FIG. 5, the summary region 141b is displayed on the display 14 by scrolling downward the screen on which the calendar display region 141a is displayed.

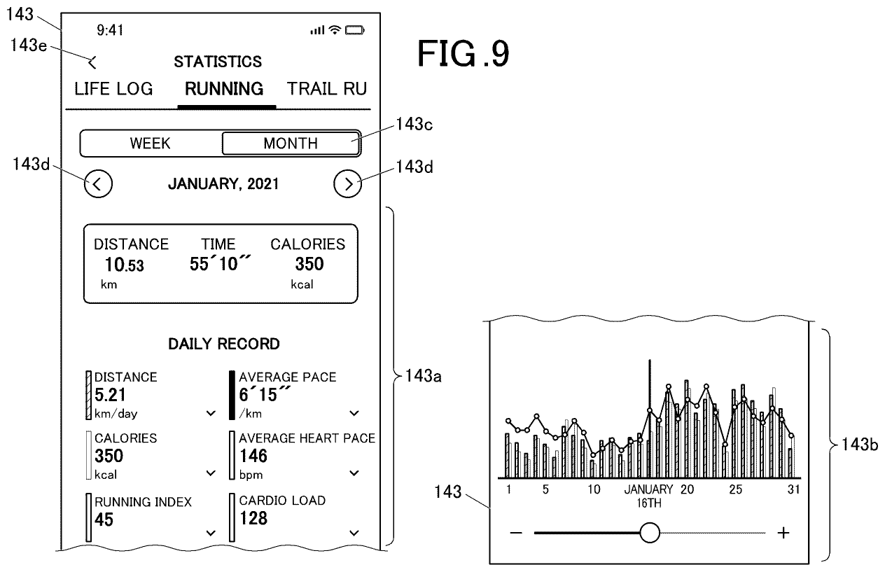

The exercise record summary 1412 displays the cumulative total of representative items (indices) for each type of exercise during the display period of the calendar. For example, in the case of running, the cumulative distance, cumulative time, cumulative calories burned, etc. are displayed. When the exercise record summary 1412 is swiped in the horizontal direction, the type of exercise to be displayed is switched. When the exercise record summary 1412 is tapped, the controller 11 displays an exercise record detailed statistics screen 143 (see FIG. 9) for the type of exercise displayed in the calendar display period (“month” in the example of FIG. 5). Note that if the display returns to the calendar screen 141 after the calendar display period has been switched on the detailed statistics screen for the life log, exercise record, etc., the period displayed in the calendar display region 141a of the calendar screen 141 is the switched (selected) period (week or month, etc.) on the detailed statistics screen. That is, the controller 11 controls so that the display period of the calendar display region 141a of the calendar screen 141 is to be linked with the period on the detailed statistics screen (the period indicated by the display unit change button 142c or the display unit change button 143c).

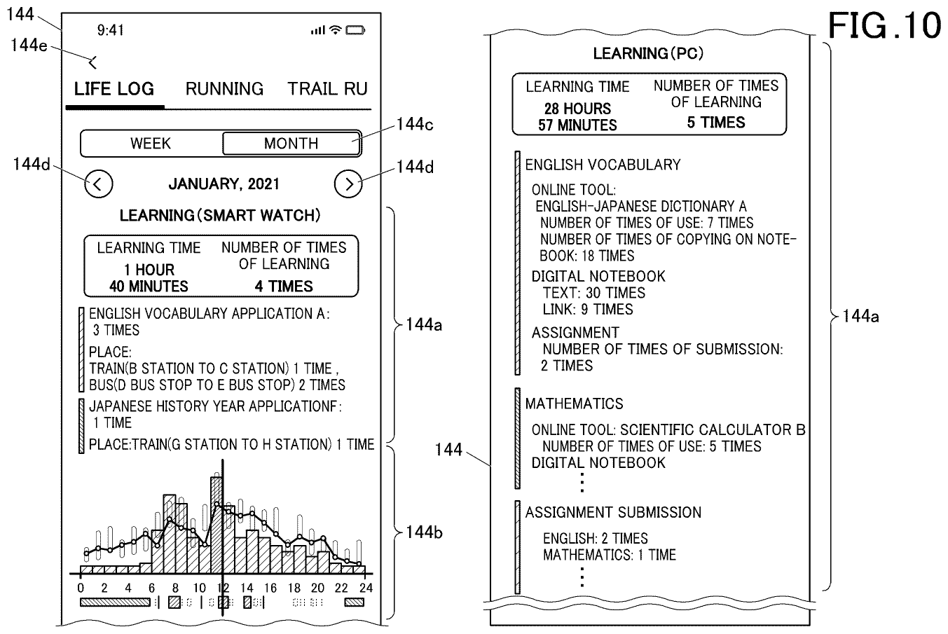

The learning record summary 1413 displays the cumulative total of representative items (indices) for each type of learning (learning device) during the display period of the calendar. For example, the cumulative learning time, cumulative number of times of learning, etc. for each type of learning are displayed. When the learning record summary 1413 is swiped in the horizontal direction, the type of learning (learning device) to be displayed is switched. When the learning record summary 1413 is (selected), the tapped controller 11 displays a learning record detailed statistics screen 144 (see FIG. 10).

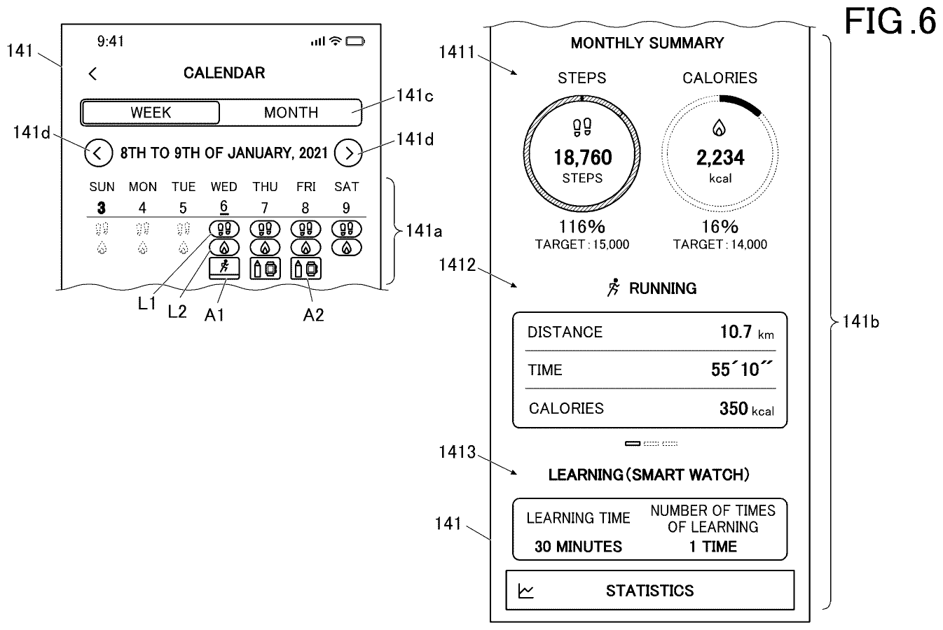

The display unit change button 141c is a button for changing the unit of display of the calendar screen 141. When “week” of the display unit change button 141c is tapped, the controller 11 changes the unit of display of the calendar to the week, and displays a weekly calendar screen 141. FIG. 6 is a diagram showing an example of the weekly calendar screen 141. When “month” of the display unit change button 141c is tapped, the controller 11 changes the unit of display of the calendar to the month, and displays a monthly calendar screen 141.

The target period change button 141d is a button for changing the display target period of the calendar screen 141. The current display target period is displayed between the two target period change buttons 141d. The display of the display target period is displayed with the term according to the present display unit. When the target period change button 141d on the right side is tapped, the display target period can be advanced in the unit of display. When the target period change button 141d on the left side is tapped, the display target period can be returned in the unit of display. The display period of the calendar can be specified by operating the display unit change button 141c and/or the target period change button 141d.

Returning to FIG. 3, in step S7, the controller 11 determines whether any summary in the summary region 141b of the calendar screen 141 has been tapped (step S7).

If it is determined that any summary on the calendar screen 141 has not been tapped (step S7; NO), the controller 11 advances the process to step S9.

If it is determined that any summary on the calendar screen 141 has been tapped (step S7; YES), the controller 11 executes detailed statistics display processing (step S8).

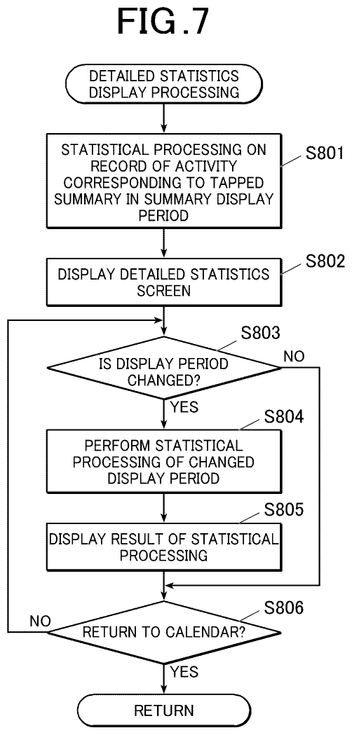

FIG. 7 is a flowchart showing a flow of the detailed statistics display processing. The detailed statistics display processing is performed by the controller 11 in coordination with the calendar app 121.

In the detailed statistics display processing, first, the controller 11 acquires data of record information of the activity corresponding to the tapped summary during the summary display period, and performs detailed statistical processing regarding the record of the activity corresponding to the tapped summary (step S801).

The items to be the target of detailed statistical processing are determined in advance for each type of activity. For example, items of detailed statistics of the life log record include cumulative number of steps, cumulative calories burned, average number of steps, average calories, heart rate range, sleep status, and the like. Items of detailed statistics of the exercise record include, for example, when the type of exercise is running, the number of times, cumulative distance, cumulative time, cumulative calories burned, average distance, average pace, average calories burned, average heart rate, etc. Items of the detailed statistics of the learning record include, for example, when the type of learning is a smart watch, the cumulative learning time, the cumulative number of times of learning, the number of times of learning or the learning time for each application used for learning, and for each learning location. When the type of learning is PC, the cumulative learning time, the cumulative number of times of learning, the number of times of learning or the learning time for each learning tool used for learning, etc. are included.

Next, the controller 11 causes the display 14 to display a detailed statistics screen on which the results of the statistical processing are displayed (step S802).

FIG. 8 is a diagram showing an example of a life log record detailed statistics screen 142. As shown in FIG. 8, the life log detailed statistics screen 142 is provided with a detailed statistics display region 142a, a graph display region 142b, a display unit change button 142c, a target period change button 142d, a return button 142e, and the like.

The detailed statistics display region 142a is a region where the results of the statistical processing in step S801 are displayed.

The graph display region 142b is a region where a graph of the number of steps and calories burned each day during the display period is displayed.

The display unit change button 142c is the button for changing the unit of display of the detailed statistics screen 142. When “week” of the display unit change button 142c is tapped, the controller 11 changes the unit of display to the week, and displays the weekly detailed statistics screen 142. When “month” of the display unit change button 142c is tapped, the controller 11 changes the unit of display to the month, and displays the monthly detailed statistics screen 142.

The target period change button 142d is a button for changing the display target period of the detailed statistics screen 142.

The return button 142e is a button for instructing to return to the calendar screen 141. In the example shown in FIG. 8, the graph display region 142b is displayed on the display 14 by scrolling downward the screen on which the detailed statistics display region 142a is displayed.

FIG. 9 is a diagram showing an example of a detailed statistics screen 143 of the exercise record. FIG. 9 shows a detailed statistics screen 143 on which detailed statistics about running are displayed. As shown in FIG. 9, the exercise record detailed statistics screen 143 is provided with a detailed statistics display region 143a, a graph display region 143b, a display unit change button 143c, a target period change button 143d, a return button 143e, and the like. The detailed statistics display region 143a is a region where the results of the statistical processing in step S801 are displayed. The graph display region 143b is a region where a graph of the distance and pace for each day during the display period is displayed. The display unit change button 143c, the target period change button 143d, and the return button 143e are similar to the above-mentioned display unit change button 142c, the target period change button 142d, and the return button 142e, respectively.

Note that the types of exercise for which statistics are displayed on the detailed statistics screen 143 may be only those displayed in the exercise record summary 1412, or may be switched to other exercise types by user operation. In the example shown in FIG. 9, the graph display region 143b is displayed on the display 14 by scrolling downward the screen on which the detailed statistics display region 143a is displayed.

FIG. 10 is a diagram showing an example of a learning detailed statistics screen 144. As shown in FIG. 10, the learning detailed statistics screen 144 is provided with a detailed statistics display region 144a and a graph display region 144b for each learning device. The learning detailed statistics screen 144 is provided with a display unit change button 144c, a target period change button 144d, a return button 144e, and the like.

The detailed statistics display region 144a for each learning device is a region where the results of the statistical processing in step S801 are displayed. The graph display region 144b for each learning device is a region where a graph of the learning time for each day on the corresponding device during the display period is displayed. It is also possible to display a graph of the daily learning time for each subject. The display unit change button 144c, the target period change button 144d, and the return button 144e are similar to the above-mentioned display unit change button 142c, the target period change button 142d, and the return button 142e, respectively.

Although the detailed statistics screen 144 in FIG. 10 displays the learning record statistics of all learning devices together, it is also possible to display only the statistics of the types displayed in the learning record summary 1413. Furthermore, the display may be switched to display the statistics of other learning types by user operation. In the example shown in FIG. 10, the detailed statistics display region 144a corresponding to the learning (PC) is displayed on the display 14 by scrolling downward the screen on which the detailed statistics display region 144a corresponding to the learning (smart watch) is displayed.

Next, the controller 11 determines whether a change in the display period has been instructed (step S803). For example, it is determined whether a change in the display period is instructed by tapping a display unit change button and/or target period change button on the displayed detailed statistics screen.

If it is determined that a change in the display period has been instructed (step S803; YES), the controller 11 performs detailed statistical processing again based on the changed display period (step S804), displays the results of the statistical processing on the detailed statistics screen (step S805), and proceeds to step S806.

If it is determined that the change in the display period has not been instructed (step S803; NO), the controller 11 proceeds the process to step S806.

In step S806, the controller 11 determines whether the return button 142e is tapped to instruct to return to the calendar screen 141 (step S806).

If it is determined that the return to the calendar screen 141 has not been instructed (step S806; NO), the controller 11 returns the process to step S803.

If it is determined that the return to the calendar screen 141 has been instructed (step S806; YES), the controller 11 proceeds the process to step S9 in FIG. 3.

In step S9 in FIG. 3, the controller 11 determines whether the change of the display period of the calendar screen 141 has been instructed (step S9).

Here, in step S9, it is determined that the change of the display period of the calendar screen 141 has been instructed not only when an instruction to change the display period is made using the display unit change button 141c or the target period change button 141d, but also when an instruction to change the display period is made on the detailed statistics screen and the display period of the detailed statistics screen is returned to the calendar screen 141 in a state different from the calendar screen 141. Thereby, the display period of the detailed statistics screen can be automatically reflected in the display period of the calendar screen 141.

If it is determined that a change in the display period of the calendar screen 141 has been instructed (step S9; YES), the controller 11 changes the display period of the calendar region 141a of the calendar screen 141 to the instructed display period (step S10), executes summary statistics display processing (step S11), and advances to step S12.

The summary statistics display processing is similar to that described with reference to FIG. 4.

In other words, when it is determined that a change of the display period of the calendar screen 141 is instructed, the controller 11 not only changes the display period of the calendar region 141a to the instructed display period, but also changes the target period for the statistical processing to the changed display period, performs statistical processing, and displays the results of the statistical processing in the summary region 141b.

If it is determined that the change in the display period of the calendar screen 141 has not been instructed (step S9; NO), the controller 11 proceeds the process to step S12.

In step S12, the controller 11 determines whether an arbitrary period is specified from the displayed calendar (step S12).

For example, when an arbitrary period in the calendar display region 141a is dragged (swiped), the controller 11 determines that the dragged period has been designated.

If it is determined that an arbitrary period has been specified from the displayed calendar (step S12; YES), the controller 11 executes summary statistics display processing for the specified period (step S13), and proceeds to step S14.

That is, the controller 11 acquires the data of the items to be displayed in the summary for each of the life log information, exercise record information, and learning record information for the specified period, and performs statistical processing. Then, the result is displayed in the summary region 141b.

If it is determined that the arbitrary period has not been designated from the displayed calendar (step S12; NO), the controller 11 proceeds the process to step S14.

In step S14, the controller 11 determines whether the end of the calendar app 121 has been instructed (step S14).

If it is determined that the end of the calendar app 121 has not been instructed (step S14; NO), the controller 11 returns the process to step S7.

If it is determined that the end of the calendar app 121 has been instructed (step S14; YES), the controller 11 ends the calendar statistical processing.

As described above, the calendar statistical processing performs statistical processing on the user's life log information, exercise record information, and learning record information for the same period as the calendar display period, and displays the results of the statistical processing. Therefore, the statistics of the user's activity record in the display period of the calendar, etc. can be easily checked by the user.

In the above embodiment, when an arbitrary period in the calendar display region 141a is dragged, the controller 11 performs statistical processing on the life log information, exercise record information, and learning record information of the dragged period, and displays the statistical results. However, the process is not limited to this.

For example, when an arbitrary period is dragged (specified) in the calendar display region 141a, the controller 11 may perform statistical processing on activity record information that satisfies predetermined conditions within the dragged period. The predetermined conditions include, for example, only running for 5 km or more, only running for 30 minutes or more, only certain types of exercise, only learning with a certain type of learning device, only learning certain subjects, etc. This condition can be set by the user by operating the inputter.

In addition, when an arbitrary period is dragged (designated) in the calendar display region 141a and then a predetermined operation is performed on the region of that period, statistical processing may be performed on the activity record information that satisfies the conditions according to the performed operation. For example, when an arbitrary period of the calendar display region 141a is dragged and then the region of the calendar display region 141a for that period is tapped twice, the controller 11 performs only the statistical processing of the exercise record information whose activity type is running. When the region is tapped three times, only statistical processing of exercise record information whose activity type is a bicycle is performed. According to the above, the conditions of information to be subjected to statistical processing can be changed according to the operation performed after dragging.

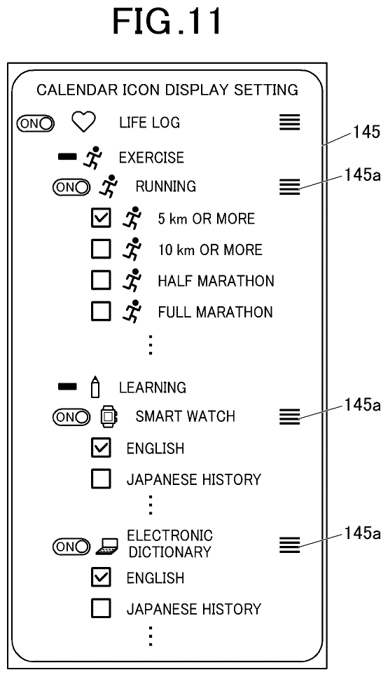

Further, a condition for displaying an icon in the calendar display region 141a may be set. FIG. 11 is a diagram showing an example of a setting screen 145 for setting display conditions for icons in the calendar display region 141a. As shown in FIG. 11, the setting screen 145 displays a list of conditions that can be set for each type of activity (for example, for running, 5 km or more, 10 km or more, etc.). Each condition that is displayed has a display ON/OFF switch (toggle switch button) and a checkbox. By checking the checkbox, it is possible to set the condition as an icon display condition and display/non-display of the icon can be set using the display ON/OFF switch. In the case of FIG. 11, for running, the running icon is displayed only on days when the user ran 5 km or more. In addition, in FIG. 11, when the icon display setting menu 145a placed on the right side of each icon is selected, an icon display order setting screen (not shown) opens on the setting screen 145, and based on the contents set on this icon display order setting screen, the arrangement order of the icons to be displayed in the calendar display region 141a can be set. Specifically, in the calendar display region 141a of FIG. 5, for example, below the date (for example, the 6th), the icon L1 (step count), icon L2 (calories burned), and icon A1 (exercise (running)) are displayed in order from the top. However, by changing the setting of the display order of the icons, the icons can be displayed as the icon A1, icon L1, and icon L2 in order from the top. This allows the user to efficiently check each icon by arranging the icons to be displayed preferentially at the top.

Furthermore, in the above embodiment, the life log information, exercise record information, and learning record information received from the sensor device 3, smart watch 4, PC 5, and electronic dictionary 6 are stored in the server 2, but it is also possible to store the above in the storage 12 of the information processing apparatus 1. Then, the controller 11 may read out the life log information, exercise record information, and learning record information from the storage 12 and perform statistical processing.

Furthermore, according to the above embodiment, the life log information, exercise record information, and learning record information are acquired from external devices such as the sensor device 3, the smart watch 4, the PC 5, and the electronic dictionary 6, but the information may be acquired from the sensor section 16 provided in the information processing apparatus 1 or various logs.

In addition, in the above embodiment, a summary of statistics for each of the life log, exercise, and learning is displayed, but a UI (User Interface) for selecting the activity for which the summary is to be displayed may be provided on the calendar screen 141, etc., and only a summary of the type of activity selected from the UI may be displayed.

In conventional mobile terminals, even if a user switches the display period of the schedule or calendar, statistics of activity records for the same period as the display period cannot be displayed. That is, there is a problem in that the user cannot easily check the statistics of the user's own activity records for the same period as the display period on the calendar or the like.

In contrast, the controller 11 of the information processing apparatus 1 according to the present embodiment displays on the display 14 a calendar screen 141 displaying a calendar in which each date of a predetermined period is displayed associated with an icon indicating the record of the user's activities on the corresponding date. The controller 11 performs statistical processing on the records of the user's activities during the display period of the calendar, and the processing results of the statistical processing are displayed on the display 14.

Therefore, the user can easily check the statistics of the user's own activity records for the same period as the display period on the calendar.

The information processing apparatus 1 also has an inputter 13 that accepts changes to the display period of the calendar through user operation. The controller 11 changes the display period of the date of the calendar to the changed display period in response to the change in the display period made on the inputter 13, changes the target period for statistical processing to the changed display period, performs statistical processing, and displays the results of the statistical processing on the display 14.

Therefore, the target period for statistical processing can be changed in conjunction with changing the display period of the calendar.

Further, when an arbitrary period is specified from the calendar displayed on the display 14, the controller 11 performs statistical processing on the record of the user's activities during the specified period, and displays the processing results of the statistical processing on the display 14.

Therefore, the user can easily check the statistics of the activity records for the specified period.

In addition, the information processing apparatus 1 acquires record information of the user's activities through the first communicator 151, and performs statistical processing based on the acquired record information. Therefore, even if the information processing apparatus 1 is not equipped with the sensor 16, it is possible to acquire activity record information and perform statistical processing.

Furthermore, since icons indicating the records of activities by the user are displayed for each type of activity, the user can easily check the records for each type of activity.

Furthermore, the controller 11 performs statistical processing for each type of activity, and displays the results of the statistical processing for each type of activity. Therefore, the user can easily check statistics of the records for each type of activity.

In addition, if the type of activity is related to exercise, the controller 11 calculates at least one of the number of times of exercise, the exercise time, the distance traveled, the calories burned, and the average pace of movement during the calendar display period through statistical processing, and displays the calculated results on the display 14. Therefore, the user can confirm at least one of the number of times of exercise, exercise time, distance traveled, calories burned, and average pace of movement performed during the display period of the calendar.

In addition, when the type of activity is related to learning, the controller 11 calculates for the display period of the calendar, through statistical processing, at least one of the number of times of learning, the learning time, the number of times of learning or learning time for each type of subject learned, the number of times of learning or learning time for each type of tool used for learning, and the number of times of learning or learning time for each location of learning, and the calculated result is displayed on the display 14. Therefore, the user can confirm, for the display period of the calendar, at least one of the number of times of learning, the learning time, the number of times of learning or learning time for each type of subject learned, the number of times of learning or the learning time for each type of tool used for learning, and the number of times of learning or the learning time for each learning location.

The description according to the above embodiments are merely a suitable example of the present invention and the present invention is not limited to the above.

For example, in the above embodiment, a case has been described in which the statistical processing of the records of activities by the user during the display period of the calendar on the display 14 is performed within the information processing apparatus 1. However, for example, an external device such as the server 2 may perform the processing.

For example, the controller 11 of the information processing apparatus 1 transmits information about the display period of the calendar on the display 14 to an external device such as the server 2 through the second communicator 152. When the controller of the server 2 receives from the information processing apparatus 1 the display period of information indicating the records of the user's activities on the display 14 via the communicator, the controller of the server 2 performs statistical processing on the records of the user's activities during the received display period and transmits the processing results of the statistical processing to the information processing device 1 via the communicator. The controller 11 of the information processing apparatus 1 receives the processing results of statistical processing for the user's activity records during the display period from the server 2 via the second communicator 152, and displays the processing results of the statistical processing on the display 14.

According to the above embodiments, a semiconductor memory is used as the computer readable storage medium storing the program regarding the above disclosure but the examples are not limited to the above. As the computer readable medium, a hard disk, a SSD, a portable recording/storage medium, such as a CD-ROM, can also be used. A carrier wave is also applied as a medium providing the program data according to the present invention via a communication line.

In addition to the above, detailed configurations and detailed operation of the components of the information processing apparatus can also be appropriately modified without departing from the scope of the present invention.

Although the embodiments of the present disclosure have been described above, the technical scope of the invention is not limited to the embodiments described above, but is defined based on the scope of the claims. Furthermore, the technical scope of the present disclosure includes equivalents in which modifications that are not related to the essence of the present disclosure are added to the scope of the claims.

What is claimed is:

1. An information processing apparatus comprising:
a display;
a memory that stores a program; and
at least one processor that executes the program,
wherein the processor is configured to,
display each date of a predetermined period on the display in association with information indicating a record of a user's activity on the date, and
perform statistical processing on the record of the user's activity during the predetermined period, and display a processing result of the statistical processing on the display.

2. The information processing apparatus according to claim 1, further comprising an inputter that receives a change in the predetermined period by user operation,
wherein the processor changes the display period of the date to the changed predetermined period in response to the change of the predetermined period on the inputter, performs statistical processing on the record of the activity during the changed predetermined period, and displays the processing result of the statistical processing on the display.

3. The information processing apparatus according to claim 2, wherein the processor performs statistical processing on the record of the user's activity during a period specified by the user operation among dates of the predetermined period displayed on the display, and displays the processing result of the statistical processing on the display.

4. The information processing apparatus according to claim 1, further comprising a communication device that acquires record information of a user's activity,
wherein the processor performs the statistical processing based on the record information acquired by the communication device.

5. The information processing apparatus according to claim 1, wherein the processor displays on the display the information indicating a record of the user's activity for each type of activity.

6. The information processing apparatus according to claim 1, wherein the processor performs the statistical processing for each type of activity, and displays the processing result of the statistical processing for each type of activity on the display.

7. The information processing apparatus according to claim 1, wherein, if the type of activity is related to exercise, the processor calculates at least one of a number of times of exercise, exercise time, a distance traveled, calories burned, and average pace of movement during the predetermined period by statistical processing, and displays a calculated result on the display.

8. The information processing apparatus according to claim 1, wherein, if the type of activity is related to learning, the processor calculates for the predetermined period, by statistical processing, at least one of a number of times of learning, learning time, a number of times of learning or learning time for each type of subject learned, a number of times of learning or learning time for each type of tool used for learning, and a number of times of learning or learning time for each location of learning, and displays a calculated result on the display.

9. The information processing apparatus according to claim 1, wherein the processor is configured to,
display on the display a first icon as information indicating the record of the user's activity when a value indicating the record of the activity satisfies a target value of the activity, and
display on the display a second icon with a display manner different from the first icon as information indicating the record of the user's activity when a value indicating the record of the activity does not satisfy a target value of the activity.

10. A server comprising:
a communication device;
a memory that stores a program; and
at least one processor that executes the program,
wherein the processor is configured to,
receive a display period of information indicating a record of an activity by a user on a display from an information processing apparatus including the display via the communication device,
perform statistical processing on the record of the user's activity during the received display period, and
transmit the processing result of the statistical processing to the information processing apparatus via the communication device.

11. An information processing apparatus comprising:
a display;
a communication device;
a memory that stores a program; and
at least one processor that executes the program,
wherein the processor is configured to,
display each date of a predetermined period on the display in association with information indicating a record of a user's activity on the date, and
transmit information of the predetermined period to an external device via the communication device, receive a processing result of statistical processing on a record of a user's activity during the predetermined period from the external device via the communication device, and display the processing result of the statistical processing on the display.

12. A display method used in an information processing apparatus including a display, the method comprising:
displaying each date of a predetermined period on the display in association with information indicating a record of a user's activity on the date, and
performing statistical processing on the record of the user's activity during the predetermined period, and displaying a processing result of the statistical processing on the display.

13. The display method according to claim 12, further comprising,
changing the display period of the date to the changed predetermined period in response to the change of the predetermined period on an inputter that receives a change in the predetermined period by user operation,
performing statistical processing on the record of the activity during the changed predetermined period, and
displaying the processing result of the statistical processing on the display.

14. The display method according to claim 13, further comprising performing statistical processing on the record of the user's activity during a period specified by the user operation among dates of the predetermined period displayed on the display, and displaying the processing result of the statistical processing on the display.

15. The display method according to claim 12, further comprising, performing the statistical processing based on the record information acquired by a communication device that acquires record information of a user's activity.

16. The display method according to claim 12, further comprising performing the statistical processing for each type of activity, and displaying the processing result of the statistical processing for each type of activity on the display.

17. The display method according to claim 12, wherein, if the type of activity is related to exercise, calculating at least one of a number of times of exercise, exercise time, a distance traveled, calories burned, and average pace of movement during the predetermined period by statistical processing, and displaying a calculated result on the display.

18. The display method according to claim 12, wherein, if the type of activity is related to learning, calculating for the predetermined period, by statistical processing, at least one of a number of times of learning, learning time, a number of times of learning or learning time for each type of subject learned, a number of times of learning or learning time for each type of tool used for learning, and a number of times of learning or learning time for each location of learning, and displaying the calculated result on the display.

19. The display method according to claim 12, further comprising,
displaying on the display a first icon as information indicating the record of the user's activity when a value indicating the record of the activity satisfies a target value of the activity, and
displaying on the display a second icon with a display manner different from the first icon as information indicating the record of the user's activity when a value indicating the record of the activity does not satisfy a target value of the activity.

20. A non-transitory computer-readable storage medium having a program stored thereon for controlling a computer including a display, a memory that stores a program, and at least one processor that executes the program, wherein the program controls the processor to,
display each date of a predetermined period on the display in association with information indicating a record of a user's activity on the date, and
perform statistical processing on the record of the user's activity during the predetermined period, and display a processing result of the statistical processing on the display.
